(19) United States
(12) Patent Application Publication
(10) Pub. No.: US 2025/0329145 A1
(43) Pub. Date: Oct. 23, 2025

(54) METHOD AND SYSTEM FOR GENERATING CAPTION RELATED TO IMAGE

(71) Applicant: SAMSUNG SDS CO., LTD., Seoul (KR)

(72) Inventors: Jeong Hyung PARK, Seoul (KR); Kang Cheol KIM, Seoul (KR); Jeong Seon YI, Seoul (KR)

(73) Assignee: SAMSUNG SDS CO., LTD., Seoul (KR)

(21) Appl. No.: 19/088,491

(22) Filed: Mar. 24, 2025

(30) Foreign Application Priority Data
Apr. 17, 2024 (KR) 10-2024-0051111
Aug. 30, 2024 (KR) 10-2024-0117404

(51) Int. Cl. G06V 10/774; G06F 40/40; G06V 10/82

(52) U.S. Cl. CPC G06V 10/774; G06F 40/40; G06V 10/82

(57) ABSTRACT

There is provided a method for generating a caption, performed by a computing system. The method may comprise acquiring a first query embedding by inputting a first image and first text into an encoding model, wherein the encoding model is configured to output the first query embedding, in which features of at least one of the first image or the first text are reflected and acquiring a caption, in which features of the first image are reflected, by inputting the first query embedding and the first text into a language model.

### CROSS-REFERENCE TO RELATED APPLICATIONS

This application claims priority from Korean Patent Application No. 10-2024-0051111 filed on Apr. 17, 2024 and Korean Patent Application No. 10-2024-0117404 filed on Aug. 30, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method for generating a caption related to an image, and more specifically, to a method and system for generating a caption that corresponds to an image by using a captioning model.

### 2. Description of the Related Art

A large multimodal model (LMM), which receives both text and images as input and performs composite analysis, is being utilized. An LMM is an artificial intelligence (AI) model that performs computations based on multimodal or various modal data, including text, images, and audio, and then outputs the results of the computations. That is, an LMM receives multimodal data or various modal data as input and outputs data by performing computations based on the input multimodal or modal data.

To improve the performance of an LMM, a dataset used for pre-training is important. A dataset used for training an LMM includes images and text (commonly known as captions). Captions related to images may be generated through human review or manual work. However, such a manual approach requires substantial labor and may introduce noise into the dataset due to human errors.

Meanwhile, text and images used for training an LMM model can be acquired through web collection. However, the acquired text and images often contain noise, making them difficult to use for training an LMM. Furthermore, when the acquired images contain a large amount of text, the acquired text is often irrelevant to the text within the acquired images. If such acquired text and images are used for training an LMM, improving the performance of the LMM becomes difficult.

Accordingly, there is a need for a technology that can automatically generate a training dataset that enhances the performance of an LMM.

### SUMMARY

An objective of the present disclosure is to provide a method and system for automatically generating a high-quality training dataset used for large multimodal model (LMM) training.

Another objective of the present disclosure is to provide a method and system for generating a caption that corresponds to an image and contains rich vocabulary.

Yet another objective of the present disclosure is to provide a method and system for determining a high-quality training dataset by filtering out noisy data.

Still another objective of the present disclosure is to provide a method and system for training a captioning model to output a high-quality caption.

The objectives of the present disclosure are not limited to those mentioned above, and other objectives not explicitly stated will be clearly understood by those skilled in the art based on the following description.

According to an aspect of the present disclosure, there is provided a method for generating a caption, performed by a computing system, the method may comprise acquiring a first query embedding by inputting a first image and first text into an encoding model, wherein the encoding model is configured to output the first query embedding, in which features of at least one of the first image or the first text are reflected and acquiring a caption, in which features of the first image are reflected, by inputting the first query embedding and the first text into a language model.

In some embodiments, the method may further comprise before the acquiring the first query embedding, acquiring the first image and the first text included in a web page through web crawling.

In some embodiments, the method may further comprise before the acquiring the first query embedding, inputting a second image and second text into the encoding model, computing a loss based on a second query embedding and a text embedding output from the encoding model, and training the encoding model based on the computed loss.

In some embodiments, the computing the loss may comprise computing the loss based on at least one of an image-text contrastive (ITC) loss, an image-grounded text generation (ITG) loss, or an image-text matching (ITM) loss.

In some embodiments, the encoding model may include a self-attention module configured to output the text embedding by performing a self-attention operation based on an embedding for the second text and an embedding for a learnable query, and a cross-attention module configured to output the second query embedding by performing a cross-attention operation based on the text embedding and an embedding for the second image and based on the computed loss, a weight of at least one of the self-attention module or the cross-attention module is adjusted, and the learnable query may be modified.

In some embodiments, the method may further comprise before the acquiring the first query embedding, acquiring a third query embedding by inputting third text and a third image into the encoding model, inputting the third query embedding and the third text into the language model, computing a loss between a caption output from the language model and the third text and training at least one of the encoding model or the language model based on the computed loss.

In some embodiments, the method may further comprise before the acquiring the first query embedding, acquiring a fourth query embedding by inputting fourth text and a fourth image having a specific format into the encoding model, inputting the fourth query embedding and the fourth text into the language model, computing a loss between a caption output from the language model and the fourth text and training at least one of the encoding model or the language model based on the computed loss.

In some embodiments, the encoding model may be configured to generate a text embedding by performing a self-attention operation based on an embedding for the first text and an embedding for a learnable query, and output the first query embedding by performing a cross-attention operation based on the text embedding and an embedding for the first image.

In some embodiments, the method may further comprise after the acquiring the caption, generating synthetic data including the caption and the first image.

In some embodiments, the method may further comprise inputting the caption and the first image included in the synthetic data into a filtering model and determining whether to use the synthetic data as training data based on an output of the filtering model.

In some embodiments, the filtering model may be configured to output a fifth query embedding and a text embedding, in which features of at least one of the first image or the caption are reflected, and when a similarity between the fifth query embedding and the text embedding exceeds a threshold, the synthetic data is determined as the training data.

In some embodiments, the method may further comprise before the inputting the caption and the first image into the filtering model, inputting fifth text and a fifth image having a specific format into the filtering model, computing a loss based on a sixth query embedding and a text embedding output from the filtering model and training the filtering model based on the computed loss.

According to an aspect of the present disclosure, there is provided a method for filtering data, performed by a computing system, the method may comprise acquiring data including an image and a caption, inputting the image and caption included in the data into a filtering model, wherein the filtering model is configured to output a query embedding and a text embedding, in which features of at least one of the caption or the image are reflected and determining whether to use the data as training data based on a similarity between the query embedding and the text embedding.

In some embodiments, when the similarity exceeds a threshold, the data may be determined as the training data.

In some embodiments, the image may be an image acquired through web collection, and the caption may be acquired through web collection or acquired from a captioning model.

In some embodiments, the method may further comprise before the acquiring the data including the image and the caption, inputting text and an image having a specific format into the filtering model, computing a loss based on a query embedding and a text embedding output from the filtering model and training the filtering model based on the computed loss.

In some embodiments, the data determined to be used as the training data may be used for training a large multimodal model (LMM).

According to an aspect of the present disclosure, there is provided a method for training a captioning model, performed by a computing system, the method may comprise acquiring a first query embedding and a text embedding, in which features of at least one of a first text or a first image are reflected, by inputting the first text and the first image into an encoding model, computing a loss between the first query embedding and the text embedding and training the encoding model based on the computed loss.

In some embodiments, the method may further comprise after the training the encoding model, acquiring a second query embedding, in which features of at least one of second text or a second image are reflected, by inputting the second text and the second image into the encoding model, inputting the second query embedding and the second text into a language model, computing a loss between a caption output from the language model and the second text and training at least one of the encoding model or the language model based on the computed loss.

In some embodiments, the encoding model may include a self-attention module configured to output the text embedding by performing a self-attention operation based on an embedding for the first text and an embedding for a learnable query, and a cross-attention module configured to output the first query embedding by performing a cross-attention operation based on the text embedding and an embedding for the first image and based on the computed loss, at least one weight of the self-attention module or the cross-attention module is adjusted, and the learnable query is modified.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram illustrating how to generate a caption through a captioning model according to an embodiment of the present disclosure;

FIG. 2 is a diagram illustrating an environment in which a system for generating a caption according to an embodiment of the present disclosure is applied;

FIG. 3 is a flowchart illustrating a method for training an encoding model according to an embodiment of the present disclosure;

FIG. 4 is a diagram illustrating an encoding model according to an embodiment of the present disclosure;

FIG. 5 is a flowchart illustrating a method for training an encoding model based on captions acquired from a language model according to an embodiment of the present disclosure;

FIG. 6 is a diagram illustrating an encoding model and a language model according to an embodiment of the present disclosure;

FIG. 7 is a flowchart illustrating a method for training an encoding model and a language model according to an embodiment of the present disclosure;

FIG. 8 is a flowchart illustrating a method for training a filtering model according to an embodiment of the present disclosure;

FIG. 9 is a diagram illustrating a filtering model according to an embodiment of the present disclosure;

FIG. 10 is a flowchart illustrating a method for generating processed data according to an embodiment of the present disclosure;

FIG. 11 is a flowchart illustrating a method for determining a training dataset for a large multimodal model (LMM) according to an embodiment of the present disclosure;

FIG. 12 is a diagram illustrating how to determine a training dataset according to an embodiment of the present disclosure;

FIG. 13 is a diagram illustrating an artificial neural network model according to an embodiment of the present disclosure; and

FIG. 14 is an exemplary hardware configuration diagram illustrating a computing system that can be referenced in various embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

The terms used in this specification are explained below.

The term “caption” may include one or more words related to an image. Additionally, a caption may include natural language.

The term “embedding” may refer to expressing data such as an image and text as a multidimensional vector. As will be described later, an embedding representing specific data as a multidimensional vector may be output through an encoding model.

Embodiments of the present disclosure will hereinafter be described with reference to the accompanying drawings.

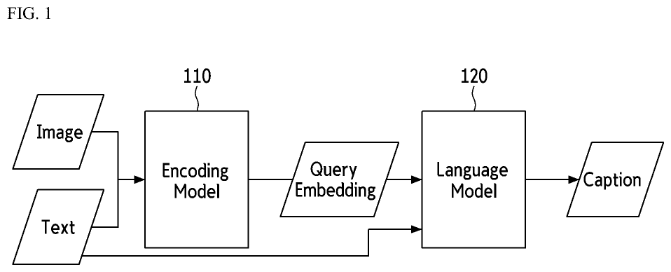

FIG. 1 is a diagram illustrating how to generate a caption through a captioning model according to an embodiment of the present disclosure.

Referring to FIG. 1, the captioning model may include an encoding model 110 and a language model 120.

An image and text, which form the basis of caption generation, may be input into encoding model 110. An image and text collected through web crawling may be input into encoding model 110. Here, the text may be extracted from an image description, image title, and related hashtag.

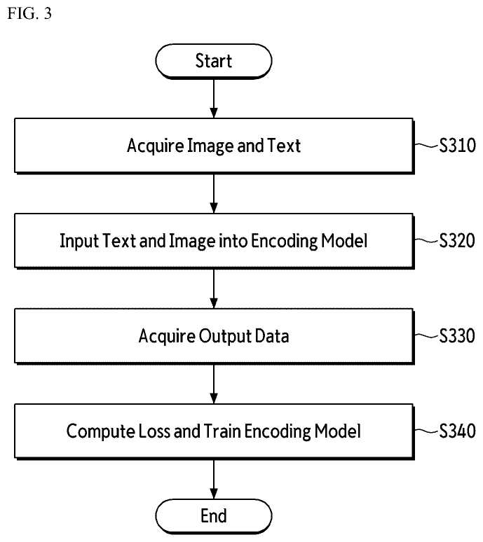

According to one embodiment, the encoding model 110 may output encoded data by performing computations based on the input image and text. According to one embodiment, the encoded data may include at least one of a text embedding or a query embedding. Here, the query embedding may be acquired through an attention operation. A detailed explanation of how to output a query embedding through the encoding model 110 will be provided later with reference to FIGS. 3 through 6.

The language model 120 may output a caption reflecting the query embedding based on the query embedding and text. For example, the language model 120 may perform an operation such as transforming or reconstructing input text to correspond to the query embedding, thereby generating and outputting a caption. The language model 120 may be referred to as a large language model (LLM).

As illustrated in FIG. 1, a caption that corresponds to an image and is related to the image may be acquired through the encoding model 110 and the language model 120 included in the captioning model. The caption may include text describing the actions or characteristics of the image. For example, if an image depicting a soccer stadium in the rain with an electronic scoreboard displaying “3-0” and text reading “Team A: Team B Soccer” is input into the captioning model, the captioning model may output a caption that reads, “Team A won a rainy soccer match against Team B with a score of 3 to 0.”

Additionally, training data that includes a caption and an image may be generated. That is, a caption may be generated based on text and an image acquired through web crawling, and the generated caption, along with the acquired image, may constitute training data. In other words, while the acquired image is used as is, the generated caption, instead of the acquired text, may be used as training data.

When captions generated through the captioning model are used for training an LMM, the training performance of the LMM may be improved. That is, by replacing acquired text with refined captions generated by the captioning model, the training time of the LMM can be reduced, and training performance can be enhanced.

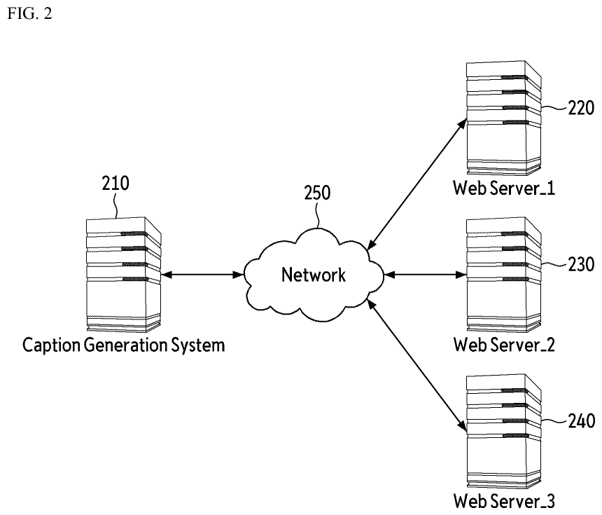

FIG. 2 is a diagram illustrating an environment in which a system for generating a caption according to an embodiment of the present disclosure is applied.

Referring to FIG. 2, a system 210 (hereinafter, the caption generation system 210) for generating a caption) may communicate with a plurality of web servers 220, 230, and 240 through a network 250.

The web servers 220, 230, and 240 may store a plurality of images and related text for each image. The images and related text may be registered on an online bulletin board.

The caption generation system 210 may access each of the web servers 220, 230, and 240 to collect a plurality of images included in web pages along with a plurality of pieces of related text. According to one embodiment, the caption generation system 210 may extract a pair of an image and text that are associated with each other from the collected images and pieces of text. The extracted image and text may then be input into the captioning model, thereby acquiring a caption related to at least one of the extracted image or text. The caption generation system 210 may generate training data that includes the acquired caption and the extracted image. Through this, a number of training data that is n times the number of collected images or pieces of texts may be generated, where n is a positive real number.

The generated training data may be subject to a filtering process through a filtering model to be described later, and training data that passes the filtering process may be included in a dataset for training an LMM.

A training method for an encoding model, a language model, and a filtering model and a data filtering method using the filtering model will hereinafter be described with reference to FIGS. 3 through 12.

Methods according to embodiments to be described below are merely exemplary implementations for achieving the objectives of the present disclosure, and certain steps may be added or omitted as needed. Furthermore, the methods illustrated in FIGS. 2 through 12 may be performed by at least one processor included in the caption generation system 210. For convenience, the methods illustrated in FIGS. 2 through 12 are assumed to be performed by the caption generation system 210 of FIG. 1.

FIG. 3 is a flowchart illustrating a method for training an encoding model according to an embodiment of the present disclosure.

Referring to FIG. 3, a caption generation system may acquire an image and text used to train an encoding model (S310). According to one embodiment, the image and text may be acquired through web crawling. For example, the caption generation system may access a web server and acquire an image included in a web page along with text related to the image. Here, the text may include a hashtag, a title assigned to the image, or a description posted for the image. That is, when the image is collected from a web server, the related text (e.g., the title, descriptions, or hashtag) may also be collected.

Thereafter, the caption generation system may input the acquired text and image into an encoding model (S320). According to one embodiment, the encoding model may perform a computation based on the acquired text and image and output a query embedding and a text embedding as the result of the computation. The query embedding may reflect the features of the acquired image.

Thereafter, the caption generation system may acquire output data, which is the result of the computation performed based on the acquired text and image, from the encoding model (S330). The output data may include a query embedding and a text embedding.

Thereafter, the caption generation system may compute a loss based on the query embedding and text embedding and train the encoding model based on the computed loss (S340). That is, the caption generation system may compute the loss between the query embedding and text embedding and train the encoding model based on the computed loss. For example, the caption generation system may use at least one of a first function for computing image-text contrastive (ITC) loss, a second function for computing image-grounded text generation (ITG) loss, or a third function for computing image-text matching (ITM) loss to compute the loss between the query embedding and text embedding.

Two or more of the above-mentioned first, second, and third functions may be used, in which case the average or weighted sum of the losses computed by the first, second, and third functions may be used to compute the loss between the query embedding and text embedding.

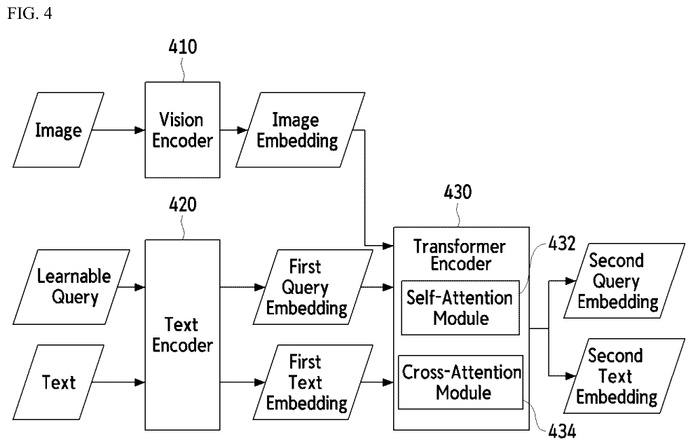

FIG. 4 is a diagram illustrating an encoding model according to an embodiment of the present disclosure.

Referring to FIG. 4, the encoding model may include a vision encoder 410, a text encoder 420, and a transformer encoder 430. According to one embodiment, the vision encoder 410 and the text encoder 420 may constitute an embedding layer.

An image acquired through web crawling may be input into the vision encoder 410, which encodes the input image and outputs an image embedding. The image embedding may be expressed as a multidimensional vector, and may reflect features of the input image.

Text acquired through web crawling (i.e., text related to an image) may be input into the text encoder 420, and the text encoder 420 may output a first text embedding. According to one embodiment, first text may be tokenized before being input into the text encoder 420. Additionally, the first text embedding may be expressed as a multidimensional vector, and may reflect features of the acquired text.

A learnable query may also be input into the text encoder 420, and the text encoder 420 may output a first query embedding. According to one embodiment, the learnable query may be tokenized before being input into the text encoder 420. In some embodiments, when the encoding model is initially trained, the learnable query may be randomly selected and then input into the text encoder 420. The learnable query, which is a parameter included in the encoding model, may be defined with a certain size, and may be modified as training progresses. According to one embodiment, the learnable query may be defined as an n x m-dimensional vector, where n and m are natural numbers. The size of the learnable query may be determined based on the size of at least one of the image embedding or the text embedding.

The learnable query, which serves as a key factor in the computation of attention modules 432 and 434 included in the transformer encoder 430, may be optimized through iterative training.

The image embedding, the first query embedding, and the first text embedding may be input into the transformer encoder 430, and the transformer encoder 430 may perform a computation based on the image embedding, the first query embedding, and the first text embedding, thereby outputting a second query embedding and a second text embedding.

The transformer encoder 430 may include a self-attention module 432 and a cross-attention module 434.

The self-attention module 432 may perform a self-attention operation based on the first query embedding and the first text embedding, thereby outputting a second text embedding, in which the features of at least one of the first query embedding or the first text embedding are reflected. By comparing the second text embedding after the self-attention operation with the first text embedding before the self-attention operation, it may be seen that the features of the first query embedding (i.e., the learnable query) may be reflected in the second text embedding.

The cross-attention module 434 may perform a cross-attention operation based on the second text embedding output from the self-attention module 432 and the image embedding and output a second query embedding as the result of the cross-attention operation. By comparing the second query embedding after the cross-attention operation with the first query embedding before the cross-attention operation, it may be observed that the features of the image embedding may be reflected in the second query embedding.

A loss may be computed based on the second query embedding and the second text embedding output from the transformer encoder 430, and the computed loss may be reflected in the encoding model, thereby adjusting at least one weight constituting the encoding model and modifying the learnable query. For example, based on the computed loss, at least one weight included in the vision encoder 410, at least one weight included in the text encoder 420, and at least one weight included in the transformer encoder 430 may be adjusted, and the learnable query input into the text encoder 420 may be modified.

According to one embodiment, an ITC-based first loss may be computed between the second query embedding and the second text embedding. Additionally, an ITG-based second loss may be computed between the second query embedding and the second text embedding. Furthermore, an ITM-based third loss may be computed between the second query embedding and the second text embedding.

The computed first, second, and third losses may be averaged or summed, and the resulting average or sum may be fed back into the encoding model, thereby adjusting at least one weight constituting the encoding model and modifying the learnable query.

By repeatedly inputting the same image and text into the encoding model for a predetermined number of times, the encoding model may be trained.

Additionally, the encoding model may be trained by inputting different images and different pieces of text collected through web crawling. For example, the training of the encoding model may be performed using multiple images and multiple pieces of text collected through web crawling. When the encoding model is repeatedly trained, at least one weight included in the encoding model may converge to an optimal value.

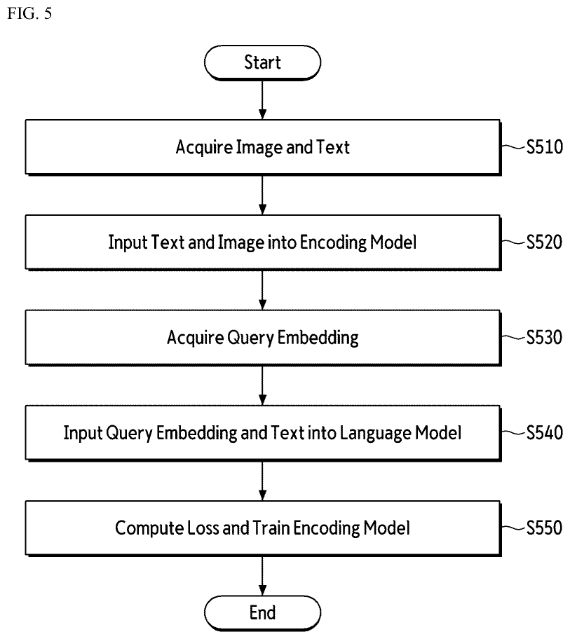

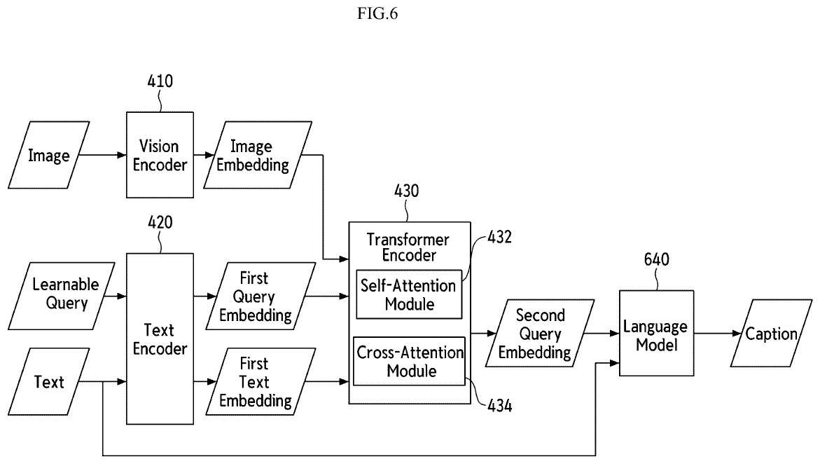

A method for additionally training an encoding model based on a caption acquired from a language model, according to an embodiment of the present disclosure, will hereinafter be described with reference to FIGS. 5 and 6.

FIG. 5 is a flowchart illustrating a method for training an encoding model based on a caption acquired from a language model, according to an embodiment of the present disclosure.

The method of FIG. 5 may be performed following the method of FIG. 3. That is, an encoding model pre-trained through the method of FIG. 3 may be further trained through the method of FIG. 5.

Referring to FIG. 5, the caption generation system may acquire an image and text through web crawling (S510).

Thereafter, the caption generation system may input the text and image into the encoding model (S520). According to one embodiment, the encoding model may perform a computation based on the text and image and output a query embedding and a text embedding as a result of the computation.

Thereafter, the caption generation system may acquire the query embedding output from the encoding model (S530).

Then, the caption generation system may input the query embedding and text into a language model (S540). According to some embodiments, the caption generation system may input the query embedding into the language model in the form of a prefix so that the query embedding may be projected. In this case, the language model may generate and output a caption based on the query embedding and text. For example, the caption, which reflects the characteristics of the query embedding, may be generated by processing, modifying, or expanding the text based on the query embedding.

Thereafter, the caption generation system may compute a loss between the caption acquired from the language model and the text input into the encoding model, and may train the encoding model by reflecting the computed loss in the encoding model to (S550). According to some embodiments, the caption generation system may compute a loss related to the similarity between the caption and the text. When computing similarity, a function for computing cosine similarity or Euclidean distance may be used.

Additionally, the caption generation system may train the language model by reflecting the computed loss in the language model. In this case, weights included in the language model may be adjusted based on the computed loss.

The method of FIG. 5 is a training method for a single cycle, and the training of the encoding model may be performed according to the number of images and pieces of text acquired through web crawling. As iterative training progresses, the language model can output a caption that contains rich and accurate information on each image.

FIG. 6 is a diagram illustrating an encoding model and a language model according to an embodiment of the present disclosure.

Referring to FIG. 6, the encoding model may include a vision encoder 410, a text encoder 420, and a transformer encoder 430. The vision encoder 410, the text encoder 420, and the transformer encoder 430 in FIG. 6 may correspond to the vision encoder 410, the text encoder 420, and the transformer encoder 430, respectively, in FIG. 4.

A second query embedding and text may be input into a language model 640, and the language model 640 may generate and output a caption representing the image based on the second query embedding and the text. That is, the encoding model may be trained to effectively represent an image as a query, and may thereby output the second query embedding based on the image, and the language model 640 may generate and output a caption that accurately reflects the second query embedding.

A loss between the caption output from the language model 640 and the text input into the encoding model may be computed, and the encoding model may be trained based on the computed loss. That is, at least one weight included in the vision encoder 410, the text encoder 420, and the transformer encoder 430 constituting the encoding model may be adjusted, and a learnable query may be modified. Additionally, the language model 640 may be trained based on the computed loss.

Meanwhile, a captioning model may be further trained (i.e., fine-tuned) to output a caption in a specific format.

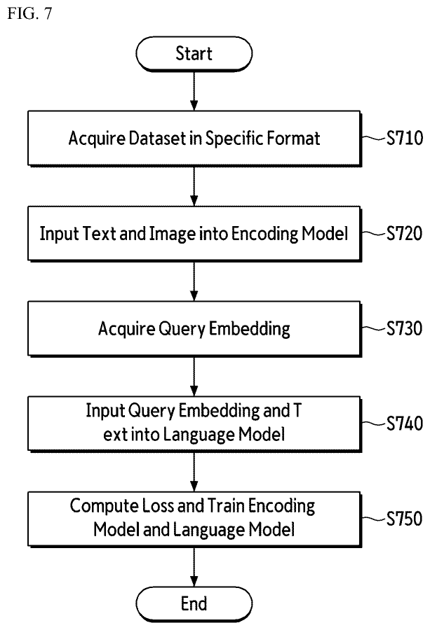

A method for fine-tuning a captioning model will hereinafter be described with reference to FIG. 7.

FIG. 7 is a flowchart illustrating a method for training an encoding model and a language model according to an embodiment of the present disclosure.

Referring to FIG. 7, the caption generation system may acquire a tuning dataset having a specific format (S710). Here, the tuning dataset may include an image and text describing an object included in the image. Additionally, the text may be in natural language. For example, the image may include an object related to a person on a beach, and the text related to the image may include an annotation that reads, “a person playing on the beach.” For example, the tuning dataset may include a dataset in compliance with the Common Objects in Context (COCO) standard. Additionally or alternatively, the tuning dataset may include a dataset in compliance with the TextCaps standard. When a dataset in compliance with the COCO standard and/or the TextCaps standard is used, the usability and accuracy of the caption output from a captioning model may be improved.

The caption generation system may extract a pair of an image and text from the tuning dataset for further training of the captioning model and input the extracted image and text into the encoding model (S720). According to one embodiment, the encoding model may perform a computation based on the text and image and may output a query embedding and a text embedding as a result of the computation.

Thereafter, the caption generation system may acquire the query embedding output from the encoding model (S730).

Then, the caption generation system may input the query embedding and text into the language model (S740). According to some embodiments, the caption generation system may input the query embedding into the language model in the form of a prefix so that the query embedding may be projected. In this case, the language model may generate and output a caption based on the query embedding and text.

Thereafter, the caption generation system may compute a loss between the caption acquired from the language model and the text input into the encoding model, and may train the encoding model and the language model by reflecting the computed loss in both the encoding model and the language model (S750). According to some embodiments, the caption generation system may compute a loss related to the similarity between the caption and the text. In this case, weights included in the language model may be adjusted based on the computed loss.

The method of FIG. 7 is a training method for a single cycle, and the training of the encoding model and the language model may be performed according to the number of images and pieces of text included in the tuning dataset, thereby fine-tuning the captioning model.

Once the fine-tuning of the captioning model is complete, the caption output from the captioning model may have a similar format to the text included in the tuning dataset. For example, the caption output from the captioning model may be in a format similar to the COCO format or the TextCaps format.

Meanwhile, a filtering model for filtering training data may be constructed. The filtering model may include the aforementioned encoding model.

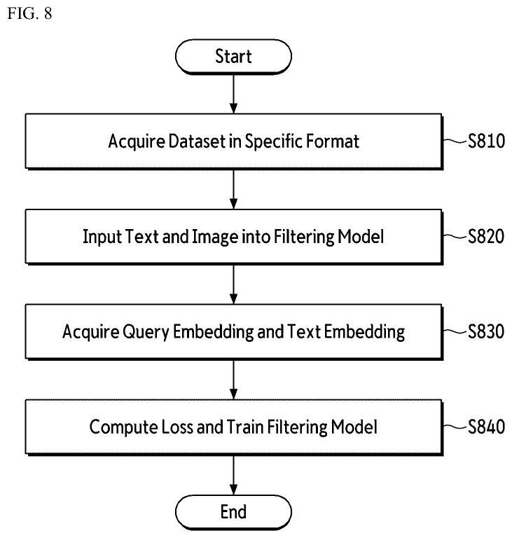

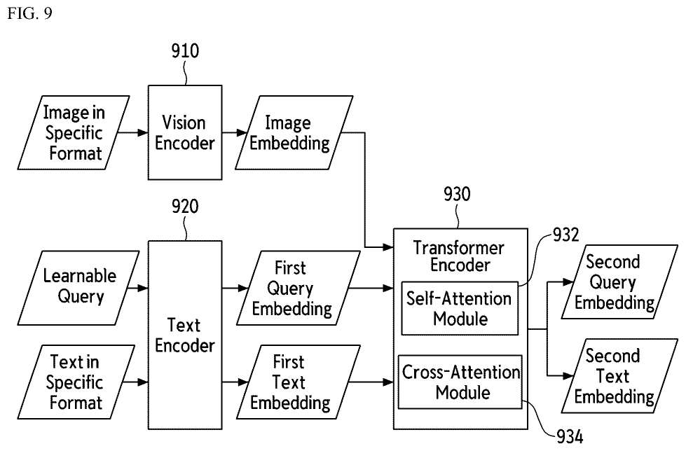

A method for training and constructing a filtering model will hereinafter be described with reference to FIGS. 8 and 9.

FIG. 8 is a flowchart illustrating a method for training a filtering model according to an embodiment of the present disclosure.

Referring to FIG. 8, the caption generation system may acquire a dataset in a specific format (S810). According to one embodiment, the dataset may have the same format as the aforementioned tuning dataset.

Thereafter, the caption generation system may input a pair of text and an image included in the dataset into the filtering model (S820). According to one embodiment, the filtering model may include an encoding model that has been pre-trained through the training method of

FIG. 3, in which case the text and image may be input into the encoding model included in the filtering model.

Thereafter, the caption generation system may acquire a query embedding and a text embedding, which are acquired through a computation performed based on the text and image, from the filtering model (S830).

Thereafter, the caption generation system may compute a loss based on the query embedding and text embedding and train the filtering model based on the computed loss (S840). That is, the caption generation system may compute the loss between the query embedding and text embedding and train the filtering model based on the computed loss. For example, the caption generation system may compute the loss between the query embedding and text embedding using at least one of a first function for computing ITC loss, a second function for computing ITG loss, or a third function for computing ITM loss.

Meanwhile, data acquired through web collection may include a noisy image or text. If a caption is generated based on a noisy image and text, the relevance between the caption and the image may be reduced. To address this issue, a filtering process may be necessary for data acquired from the captioning model.

FIG. 9 is a diagram illustrating a filtering model according to an embodiment of the present disclosure.

Referring to FIG. 9, the filtering model may include an encoding model, and the encoding model may include a vision encoder 910, a text encoder 920, and a transformer encoder 930. The vision encoder 910, the text encoder 920, and the transformer encoder 930 in the encoding model of the filtering model may have been pre-trained through the training method of FIG. 3.

An image in a specific format may be input into the vision encoder 910, and the vision encoder 910 may encode the image and output an image embedding.

Text in a specific format may be input into the text encoder 920, and the text encoder 920 may output a first text embedding. According to one embodiment, the first text may be tokenized before being input into the text encoder 920.

Additionally, a learnable query may be input into the text encoder 920, and the text encoder 920 may output a first query embedding. According to one embodiment, the learnable query may be tokenized before being input into the text encoder 920.

The image embedding, the first query embedding, and the first text embedding may be input into the transformer encoder 930, and the transformer encoder 930 may perform a computation based on the image embedding, the first query embedding, and the first text embedding, thereby outputting a second query embedding and a second text embedding.

The transformer encoder 930 may include a self-attention module 932 and a cross-attention module 934.

The self-attention module 932 may perform a self-attention operation based on the first query embedding and the first text embedding, thereby outputting a second text embedding, in which the features of at least one of the first query embedding or the first text embedding are reflected.

The cross-attention module 934 may perform a cross-attention operation based on the second text embedding output from the self-attention module 932 and the image embedding, thereby outputting a second query embedding as a result of the cross-attention operation.

A loss may be computed based on the second query embedding and the second text embedding output from the transformer encoder 930, and the computed loss may be reflected in the encoding model of the filtering model, thereby adjusting at least one weight constituting the encoding model and modifying the learnable query. For example, at least one weight included in the vision encoder 910, at least one weight included in the text encoder 920, and at least one weight included in the transformer encoder 930 may be adjusted based on the computed loss, and the learnable query may be modified.

According to one embodiment, an ITC-based first loss may be computed between the second query embedding and the second text embedding. Additionally, an ITG-based second loss may be computed between the second query embedding and the second text embedding. Furthermore, an ITM-based third loss may be computed between the second query embedding and the second text embedding.

The computed first, second, and third losses may be averaged or summed, and the resulting average or sum may be fed back into the filtering model, thereby adjusting at least one weight constituting the filtering model and modifying the learnable query.

The training of the filtering model may be repeatedly performed according to the number of images and pieces of text included in the dataset. When the filtering model is repeatedly trained, at least one weight included in the encoding model of the filtering model may converge to an optimal value.

The filtering model may determine whether a caption generated through the captioning model is valuable for training an LMM. That is, data that has passed through the filtering model may ultimately be used as training data.

Data including a caption generated through the captioning model will hereinafter be referred to as “synthetic data.” The synthetic data may include a caption and an image. Additionally, data including an image and text acquired through web crawling will hereinafter be referred to as “collected data.”

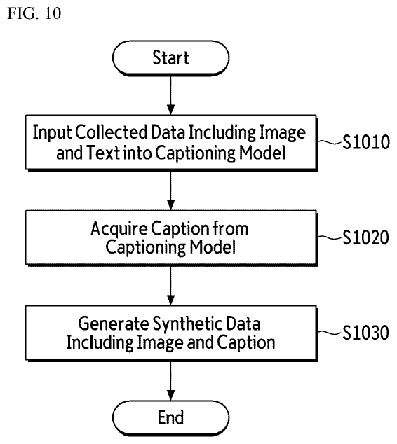

FIG. 10 is a flowchart illustrating a method for generating synthetic data according to an embodiment of the present disclosure.

Referring to FIG. 10, the caption generation system may input an image and text collected through web crawling into the captioning model (S1010). Here, the captioning model may be a model trained as described above and may include an encoding model and a language model.

Thereafter, the caption generation system may acquire a caption from the captioning model (S1020).

Thereafter, the caption generation system may generate synthetic data that includes the acquired caption and the collected image (S1030). That is, the collected text may be replaced with the acquired caption, thereby generating synthetic data.

FIG. 10 illustrates a method for generating a single piece of synthetic data, and a number of synthetic data corresponding to the number of images collected through web crawling may be generated through the method of FIG. 10.

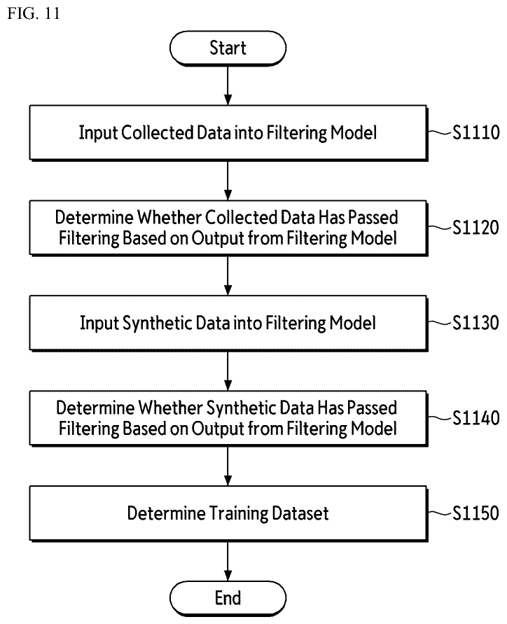

FIG. 11 is a flowchart illustrating a method for determining a training dataset for an LMM according to an embodiment of the present disclosure.

Referring to FIG. 11, the caption generation system may input collected data acquired through web crawling into the filtering model (S1110). That is, an image and text included in the collected data may be input into the filtering model.

Thereafter, the caption generation system may determine whether the collected data has passed filtering based on the output of the filtering model (S1120). That is, the caption generation system may determine whether to use the collected data as training data based on the output of the filtering model. According to one embodiment, the filtering model may input the image and text included in the collected data into the encoding model, acquire a text embedding and a query embedding from the encoding model, compute a similarity between the text embedding and the query embedding, and output information related to whether the collected data has passed filtering based on the computed similarity. For example, the filtering model may output information (e.g., a flag) indicating that the collected data has passed filtering when the computed similarity exceeds a threshold and may output information indicating that the collected data has failed filtering when the computed similarity is below the threshold.

Additionally, the caption generation system may input synthetic data, which includes a caption acquired through the captioning model, into the filtering model (S1130). That is, the image and caption included in the synthetic data may be input into the filtering model.

Thereafter, the caption generation system may determine whether the synthetic data has passed filtering based on the output of the filtering model (S1140). That is, the caption generation system may determine whether to use the synthetic data as training data based on the output of the filtering model. According to one embodiment, the filtering model may input the image and text included in the synthetic data into the encoding model, acquire a text embedding and a query embedding from the encoding model, compute a similarity between the text embedding and query embedding, and output information related to whether the synthetic data has passed filtering based on the computed similarity. For example, the filtering model may output information indicating that the synthetic data has passed filtering when the computed similarity exceeds a threshold and may output information indicating that the synthetic data has failed filtering when the computed similarity is below the threshold.

Thereafter, the caption generation system may generate a dataset including the collected and synthetic data that have passed filtering in steps S1120 and S1140, respectively, and may determine the generated dataset as a training dataset for the LMM (S1150). That is, the training dataset for the LMM may include the collected data and synthetic data that have passed filtering.

In some embodiments, the filtering model may output a query embedding and a text embedding that reflect the features of at least one of the caption or image included in the synthetic data (or the collected data). In this case, the caption generation system may determine whether to use the synthetic data (or the collected data) as training data based on the similarity between the query embedding and the text embedding. For example, the caption generation system may determine that the synthetic data (or the collected data) is to be used as training data if the similarity exceeds a threshold.

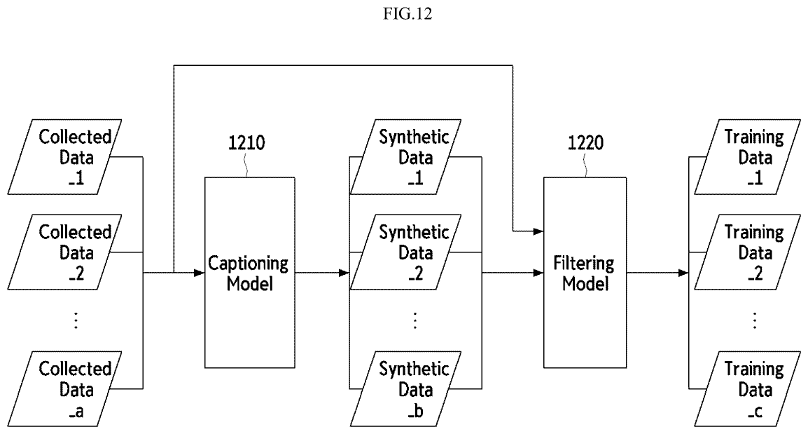

FIG. 12 is a diagram illustrating how to determine a training dataset.

Referring to FIG. 12, a plurality of pieces of collected data may be acquired through web crawling, and may then be input into a captioning model 1210, and a number of pieces of synthetic data corresponding to the number of pieces of collected data may be generated. The pieces of synthetic data may include captions generated through the captioning model 1210.

Each of the pieces of collected data may be input into a filtering model 1220, thereby acquiring a text embedding and a query embedding. The filtering model 1220 may determine whether each of the pieces of collected data has passed filtering based on the similarity between the text embedding and the query embedding. Pieces of collected data that have passed filtering may be determined as training data.

Additionally, each of the pieces of synthetic data may be input into the filtering model 1220, thereby acquiring a text embedding and a query embedding. The filtering model 1220 may determine whether each of the pieces of synthetic data has passed filtering based on the similarity between the text embedding and the query embedding. Pieces of synthetic data that have passed filtering may be determined as training data.

A plurality of pieces of training data may constitute a training dataset, and the training dataset may be used to train an LMM.

According to embodiments of the present disclosure, a training dataset that improves the performance of an LMM may be automatically generated by filtering both synthetic data acquired through the captioning model and collected data acquired through web crawling. Accordingly, the training dataset may include a variety of high-quality captions (or data) and images. An LMM trained based on the training dataset may be capable of accurately generating answers to various queries by extracting high-quality information from images, even when receiving diverse queries related to each specific image.

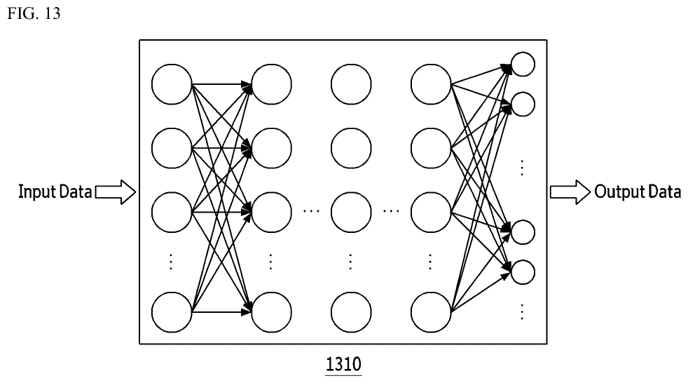

FIG. 13 is a diagram illustrating an artificial neural network model 1310 according to an embodiment of the present disclosure.

Referring to FIG. 13, the artificial neural network model 1310, which is an example of a machine learning model, may be a statistical learning algorithm implemented based on the architecture of a biological neural network, or a structure for executing the statistical learning algorithm, in the fields of machine learning and cognitive science. In some embodiments, the artificial neural network model 1310 may be included in at least one of the captioning model or the filtering model. That is, at least one of the captioning model or the filtering model may be implemented in the form of the artificial neural network model 1310.

In one embodiment, the artificial neural network model 1310, as in a biological neural network, may represent a machine learning model capable of problem-solving by repeatedly adjusting synaptic weights of artificial neurons, or nodes, which form a network through synaptic connections, to minimize the error between the correct output corresponding to a specific input and the inferred output. For example, the artificial neural network model 1310 may include a probabilistic model or a neural network model used in machine learning or deep learning.

The artificial neural network model 1310 may be implemented as a multilayer perceptron (MLP) consisting of multiple layers of nodes and their connections. The artificial neural network model 1310 may be implemented using one of various artificial neural network structures that include an MLP. The artificial neural network model 1310 may include an input layer for receiving input signals or data from an external source, an output layer for outputting signals or data corresponding to the input data, and n hidden layers (where n is a positive integer) located between the input and output layers, for receiving signals from the input layer, extracting features from the received signals, and transmitting the extracted features to the output layer.

In the artificial neural network model 1310, a plurality of input variables and a plurality of output variables respectively corresponding to the plurality of input variables may be matched at the input and output layers, respectively. By adjusting the synaptic weights between nodes included in the input, hidden, and output layers, the artificial neural network model 1310 can be trained to extract a correct output corresponding to a specific input. When the artificial neural network model 1310 is iteratively trained based on data included in a training dataset, the synaptic weights (or weights) between the nodes are adjusted to reduce the error between output variables calculated from the input variables and target outputs, eventually converging to optimal values.

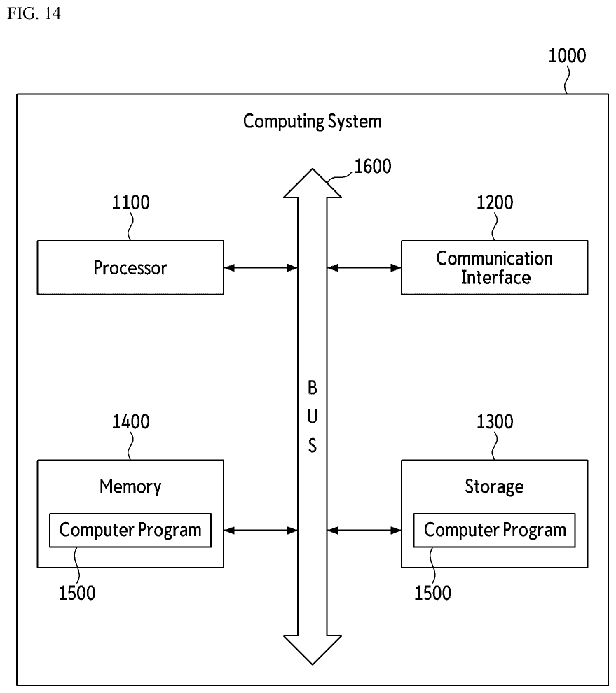

Hereinafter, a hardware configuration of an exemplary computing system according to some embodiments may be described with reference to FIG. 14. The computing system described with reference to FIG. 14 may refer to the caption generation system 210 described above.

FIG. 14 is a hardware configuration view of an exemplary computing system 1000 according to some embodiments of the present disclosure.

The computing system 1000 may include at least one processor 1100, a bus 1600, a communication interface 1200, a memory 1400, which loads a computer program 1500 to be executed by the processor 1100, and a storage 1300, which stores the computer program 1500. Only components related to the embodiment are illustrated in FIG. 14. Accordingly, a person skilled in the art to which the embodiments of the present disclosure may recognize that other general components may be included in addition to the components illustrated in FIG. 14.

The processor 1100 may control the overall operation of each of the components of the computing system 1000. The processor 1100 may be configured to include at least one of a central processing unit (CPU), a micro-processor unit (MPU), a micro-controller unit (MCU), a graphics processing unit (GPU), or any form of processor well-known in the field of the present disclosure. Additionally, the processor 1100 may perform computations for at least one application or program to execute operations/methods according to some embodiments of the present disclosure. The computing system 1000 may be equipped with one or more processors.

The memory 1400 may store various data, commands, and/or information. The memory 1400 may load the computer program 1500 from the storage 1300 to execute the operations/methods according to some embodiments of the present disclosure. The memory 1400 may be implemented as a volatile memory such as a random-access memory (RAM), but the present disclosure is not limited thereto.

The bus 1600 may provide communication functionality between the components of the computing system 1000. The bus 1600 may be implemented in various forms such as an address bus, a data bus, and a control bus.

The communication interface 1200 may support wired or wireless Internet communication of the computing system 1000. The storage 1300 may non-transitorily store at least one computer program 1500. The storage 1300 may be configured to include a non-volatile memory such as a flash memory, as well as a computer-readable recording medium in any form well-known in the technical field of the present disclosure, such as a hard disk or a removable disk.

The computer program 1500 may include one or more instructions that enable the processor 1100 to perform the operations/methods according to various embodiments of the present disclosure when loaded into the memory 1400. In other words, by executing the loaded instructions, the processor 1100 may perform the operations/methods according to various embodiments of the present disclosure. The computer program 1500 may include instructions for methods according to various embodiments described with reference to FIGS. 1 to 13.

According to one embodiment, the computer program 1500 may comprise instructions for operations of acquiring a first query embedding by inputting a first image and first text into an encoding model, wherein the encoding model is configured to output the first query embedding, in which features of at least one of the first image or the first text are reflected and acquiring a caption, in which features of the first image are reflected, by inputting the first query embedding and the first text into a language model.

In some embodiments, the computer program 1500 may comprise instructions for operations of acquiring data including an image and a caption, inputting the image and caption included in the data into a filtering model, wherein the filtering model is configured to output a query embedding and a text embedding, in which features of at least one of the caption or the image are reflected and determining whether to use the data as training data based on a similarity between the query embedding and the text embedding.

In some embodiments, the computer program 1500 may comprise instructions for operations of acquiring a first query embedding and a text embedding, in which features of at least one of the first text or the first image are reflected, by inputting a first text and a first image into an encoding model, computing a loss between the first query embedding and the text embedding and training the encoding model based on the computed loss.

In some embodiments, the computing system 1000 as described with reference to FIG. 14 may be configured using one or more physical servers included in a server farm based on cloud technology such as virtual machines. In this case, at least some of the components as illustrated in FIG. 12, such as the processor 1100, the memory 1400, and the storage 1300 may be virtual hardware, and the communication interface 1200 may also be embodied as a virtualized networking element such as a virtual switch.

So far, a variety of embodiments of the present disclosure and the effects according to embodiments thereof have been mentioned with reference to FIGS. 1 to 14. The effects according to the technical idea of the present disclosure are not limited to the forementioned effects, and other unmentioned effects may be clearly understood by those skilled in the art from the description of the specification.

The methods according to the embodiments of the present disclosure described above may be performed by executing a computer program implemented using a computer-readable code. The computer program may be transmitted from a first computing device to a second computing device via a network such as the Internet and installed on the second computing device, and may be used by the second computing device. Furthermore, although the operations are illustrated in a specific order in the drawings, it should not be understood that the operations should be executed in the specific order as illustrated or in a sequential order or that all illustrated operations should be executed to acquire a desired result. In certain situations, multitasking and parallel processing may be advantageous.

Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A method for generating a caption, performed by a computing system, the method comprising:
acquiring a first query embedding by inputting a first image and first text into an encoding model, wherein the encoding model is configured to output the first query embedding, in which features of at least one of the first image or the first text are reflected; and
acquiring a caption, in which features of the first image are reflected, by inputting the first query embedding and the first text into a language model.

2. The method of claim 1, further comprising:
before the acquiring the first query embedding, acquiring the first image and the first text included in a web page through web crawling.

3. The method of claim 1, further comprising:
before the acquiring the first query embedding, inputting a second image and second text into the encoding model;
computing a loss based on a second query embedding and a text embedding output from the encoding model; and
training the encoding model based on the computed loss.

4. The method of claim 3, wherein the computing the loss comprises computing the loss based on at least one of an image-text contrastive (ITC) loss, an image-grounded text generation (ITG) loss, or an image-text matching (ITM) loss.

5. The method of claim 3, wherein
the encoding model includes: a self-attention module configured to output the text embedding by performing a self-attention operation based on an embedding for the second text and an embedding for a learnable query; and a cross-attention module configured to output the second query embedding by performing a cross-attention operation based on the text embedding and an embedding for the second image, and
based on the computed loss, a weight of at least one of the self-attention module or the cross-attention module is adjusted, and the learnable query is modified.

6. The method of claim 1, further comprising:
before the acquiring the first query embedding, acquiring a third query embedding by inputting third text and a third image into the encoding model;
inputting the third query embedding and the third text into the language model;
computing a loss between a caption output from the language model and the third text; and
training at least one of the encoding model or the language model based on the computed loss.

7. The method of claim 1, further comprising:
before the acquiring the first query embedding, acquiring a fourth query embedding by inputting fourth text and a fourth image having a specific format into the encoding model;
inputting the fourth query embedding and the fourth text into the language model;
computing a loss between a caption output from the language model and the fourth text; and
training at least one of the encoding model or the language model based on the computed loss.

8. The method of claim 1, wherein the encoding model is configured to: generate a text embedding by performing a self-attention operation based on an embedding for the first text and an embedding for a learnable query; and output the first query embedding by performing a cross-attention operation based on the text embedding and an embedding for the first image.

9. The method of claim 1, further comprising:
after the acquiring the caption, generating synthetic data including the caption and the first image.

10. The method of claim 9, further comprising:
inputting the caption and the first image included in the synthetic data into a filtering model; and
determining whether to use the synthetic data as training data based on an output of the filtering model.

11. The method of claim 10, wherein
the filtering model is configured to output a fifth query embedding and a text embedding, in which features of at least one of the first image or the caption are reflected, and when a similarity between the fifth query embedding and the text embedding exceeds a threshold, the synthetic data is determined as the training data.

12. The method of claim 10, further comprising:
before the inputting the caption and the first image into the filtering model, inputting fifth text and a fifth image having a specific format into the filtering model;
computing a loss based on a sixth query embedding and a text embedding output from the filtering model; and
training the filtering model based on the computed loss.

13. A method for filtering data, performed by a computing system, the method comprising:
acquiring data including an image and a caption;
inputting the image and the caption included in the data into a filtering model, wherein the filtering model is configured to output a query embedding and a text embedding, in which features of at least one of the caption or the image are reflected; and
determining whether to use the data as training data based on a similarity between the query embedding and the text embedding.

14. The method of claim 13, wherein when the similarity exceeds a threshold, the data is determined as the training data.

15. The method of claim 13, wherein
the image is an image acquired through web collection, and
the caption is acquired through web collection or acquired from a captioning model.

16. The method of claim 13, further comprising:
before the acquiring the data including the image and the caption, inputting text and an image having a specific format into the filtering model;
computing a loss based on a query embedding and a text embedding output from the filtering model; and
training the filtering model based on the computed loss.

17. The method of claim 13, wherein the data determined to be used as the training data is used for training a large multimodal model (LMM).

18. A method for training a captioning model, performed by a computing system, the method comprising:
acquiring a first query embedding and a text embedding, in which features of at least one of a first text or a first image are reflected, by inputting the first text and the first image into an encoding model;
computing a loss between the first query embedding and the text embedding; and
training the encoding model based on the computed loss.

19. The method of claim 18, further comprising:
after the training the encoding model, acquiring a second query embedding, in which features of at least one of second text or a second image are reflected, by inputting the second text and the second image into the encoding model;
inputting the second query embedding and the second text into a language model;
computing a loss between a caption output from the language model and the second text; and
training at least one of the encoding model or the language model based on the computed loss.

20. The method of claim 18, wherein
the encoding model includes: a self-attention module configured to output the text embedding by performing a self-attention operation based on an embedding for the first text and an embedding for a learnable query; and a cross-attention module configured to output the first query embedding by performing a cross-attention operation based on the text embedding and an embedding for the first image, and
based on the computed loss, at least one weight of the self-attention module or the cross-attention module is adjusted, and the learnable query is modified.
